(19) United States
(12) Patent Application Publication
(10) Pub. No.: US 2012/0244517 A1
(43) Pub. Date: Sep. 27, 2012

(54) METHOD FOR ENHANCING PRECOCITY AND CREATING CHILD PRODIGIES OR PRODIGIOUS GENIUSES

(76) Inventors: Tommy James Valentine Cawley, Kuala Lumpur (MY); Ainan Celeste Cawley, Kuala Lumpur (MY)

(21) Appl. No.: 13/511,107

(22) PCT Filed: Nov. 18, 2010
(86) PCT No.: PCT/MY2010/000286

§ 371 Date: May 30, 2012

Related U.S. Application Data
(60) Provisional application No. 61/281,530, filed on Nov. 19, 2009.

(51) Int. Cl. G09B 19/00

(52) U.S. Cl. 434/433

(57) ABSTRACT

There is disclosed a method for enhancing precocity in a human subject, and further for creating child prodigies, and prodigious geniuses using synaesthesia. In one embodiment of the present invention, synaesthesia may be inherited or induced artificially.

### FIELD OF INVENTION The embodiments of the present invention relate to methods for use in enhancing the precocity of a human subject, and thus creating prodigies and prodigious geniuses.

### BACKGROUND OF THE INVENTION

Throughout the history of mankind, the emergence of several rare geniuses have astounded the world with their super-normal capacities and their revolutionary contribution in various fields, such as the well known Wolfgang Amadeus Mozart in music, John von Neumann in mathematics and Pablo Picasso and Leonardo Da Vinci in art. These geniuses, have one thing in common: they were all child prodigies.

Generally, a child prodigy is an individual, more often younger than 10 years old, who has at least one type of extraordinary capacity, recognized at a very early age, and exceptionally acquires or performs at least one skill applicable to the adult world, at the level of a highly trained adult. Child prodigies and geniuses are often categorized as extraordinary chances of nature.

Based on current researches, it can be deduced that the absolute aspects in the creation of prodigies and thus geniuses have long been mysterious. Experts have generally concluded that it is largely hereditary although there are recent science discoveries that suggest super-normal capacities are based on higher cognitive processes, located in specific areas of the brain, therefore it is envisioned, by some, that the traits of geniuses could be stimulated. Such stimulation might involve individual training with the aid of various learning modules, assessments and biofeedback modules. Nevertheless, there has been a problem in the aspect of the stimulation, as the likelihood of creating a child prodigy and thereby a genius by means of stimulating higher cognitive processes in the brain is unlikely to be as definite as genetic inheritance. Indeed, if it was possible to do so, by such means, then prodigies would be easy to make and would be common. To date, prodigiousness remains a rare phenomenon which points to genetic influences as being the over-riding causative factors in their creation. However, were the precise genetic factors understood, it would then be possible to exert some environmental influence on those processes.

Our research, referred to herein as the present invention provides a solution for the current drawbacks with respect to the prior art on the creation of prodigies and geniuses.

Our research has shown that synaesthesia is a primary influence on prodigiousness.

Synaesthesia is an uncommon occurrence related to cross-wiring of senses, whereby sight, sounds, tastes, touch or smells may be mixed or merged into different sensory impressions and associations. In other words, the stimulation of one sensory or cognitive pathway would lead to automatic always involuntary experiences in a second sensory or cognitive pathway. It is reported that synaesthesia often occurs in highly gifted and creative individuals with extraordinary memory competence. Current research has shown that there are at least sixty-two forms of synaesthesia; these include grapheme—colour synaesthesia, sound-colour synaesthesia, number form synaesthesia, ordinal-linguistic synaesthesia and lexical synaesthesia. The most common synaesthesia forms are coloured days, grapheme—colour and sound-colour synaesthesia. A graphemic—color synaesthete would see individual numbers, or letters of the alphabet in shaded or tinged colors. A piano note for a sound-colour synaesthete might be seen as crimson red when an average person would perceive it as just a simple musical note. A sound-color synaesthete would see colours when he/she hears sounds. In some extreme cases, every taste, color, sound, touch and smell could combine to produce a representation of acute sensation which a synaesthete would have to experience every waking hour, such a phenomenon would be experienced by a multiple synaesthete—a person with an assortment of synaesthesias. Similar to the occurrence of prodigies and geniuses, synaesthesia is discovered to be associated with a genetic origin or inheritance.

So far, synaesthesia has been further linked with possible neural and cognitive traits within the brain. Some experts allege that it could be caused by benign extra brain connections or may be due to cross-activation of sensing recognition areas within the brain. Ongoing research has shown that synaesthetes are often creative, with progressive development of perceptual and cognitive skills.

Our research has proven that synaesthesia promotes the development of prodigiousness and thus prodigious geniuses. Accordingly as briefly mentioned previously, synaesthesia is a primary causative factor in creating prodigiousness.

It is therefore a primary object of the present invention to provide a method for creating a prodigious genius, using synaesthesia.

It is a further object of the present invention to provide a method for enhancing precocity of a human subject, using synaesthesia.

It is yet another object of the present invention to provide a method for creating a child prodigy and prodigious genius with the influence or presence of synaesthesia.

It is further an object of the present invention to provide a method for increasing the chances of a child prodigy with the influence or presence of synaesthesia.

It is yet an object of the present invention to provide a method for creating synaesthetic genetic material for creation of prodigies.

It is yet another object of the present invention to provide a method for producing enhanced intellects, with tendencies to particular talents, types of creativity, or skills and thus career outcomes.

It is another object of the present invention to provide a method for creating prodigies with the presence of induced synaesthesia. Further objects and advantages of the present invention may become apparent upon referring to the preferred embodiments of the present invention as will be disclosed herein.

### SUMMARY OF INVENTION

There is disclosed a method for providing cognitive enhancement in a human subject comprising the step of augmenting and enhancing the precocity of the human subject using synaesthesia.

In another aspect of the present invention, there is disclosed a method for creating a child prodigy, said method comprising the step of obtaining genetic materials from a synaesthetic individual, and crossing said genetic materials with that of other people, synaesthetic or not.

In another further aspect of the present invention, there is disclosed a method for creating a genius individual comprising the steps of obtaining genetic materials from a synaesthete and transferring said obtained genetic materials into the subject individual.

In another aspect of the present invention, synaesthesia is induced artificially, by means of hypnosis, meditation or drugs or repetitive training of associations.

In yet another aspect of the present invention there is provided a non-inheritable means of achieving enhanced precocity and all the other attributes of synaesthetic mental enhancement.

### DETAILED DESCRIPTION OF THE PRESENT INVENTION

It will be convenient to further describe the present invention with respect to the accompanying figures. It should be noted that other arrangements are possible, and detailed description thereto is not intended to limit the invention to the particular form disclosed, but on the contrary, the invention is to cover all modifications, equivalents and alternatives falling within the scope of invention as defined by the appended claims. The method described as exemplifications herein may be performed in any suitable order unless otherwise indicated herein.

There is disclosed a method for use in creating prodigies, enhanced intellects or the likes with the presence, or induced by synaesthesia, regardless of the approaches used for allowing crossing of genetic information or genetic materials between two potential parents which meet the preferred criteria to be disclosed herein.

It should be noted that this document will disclose the use of the method in accordance with the preferred embodiments for creation of geniuses and the creation of child prodigies.

In accordance with an embodiment of the present invention, for the creation of child prodigies, genetic materials from parents or individuals, whereby at least one parent or individual known or tested to having the characteristics of any forms of synaesthesia, high intelligence and persistence will be crossed for reproduction. It is apparent that genetic information from the synaesthete parent or individual will be passed to the offspring. Synaesthesia is the key attribute, here, for it is the enhancer of precocity, memory and general mental powers. In order to produce or create the desired type of prodigy, it is preferred that at least one parent or individual should have the type of synaesthesia within the same area of the desired type of prodigy to be passed on to the offspring. This disclosure teaches that any form of synaesthesia will increase the chances of producing a prodigious child, as the presence of synaesthesia would significantly aid in enhancing precocity for the child.

Suitably, based on a preferred embodiment of the present invention, synaesthesia may be genetically inherited as proposed with the method or it may be created or induced artificially, by means of pharmaceutically or therapeutically effective amount of drugs related or other appropriate means, for instance but not limiting to hypnosis, or meditation for stimulating or creating synaesthetic effect within the brain. Irrefutably, the various means of creating synaesthesia do not alter the end result and thus would still lead to enhancement of precocity and cognitive skills in the child. Thus, it should be understood that the induction of synaesthesia in a developing child in accordance with the present invention, may vary including, but not limiting to, genetic, chemical based means, medical based means or drug related, hypnotic or other means, such as repetitive training so as to facilitate the development of superior mental powers, in that child, in terms of memory, creativity, or precocity, or any other mental benefits, such as intelligence, or to help determine adult career choice, for instance, as a musician, by creating a predisposition to a particular form of creativity.

It should be further noted that induction of synaesthesia for the method of the present invention may not only be used to create prodigious minds or child prodigies but to also impart cognitive enhancement, or providing enhanced precocity, particularly in the area of memory or ease of learning, in enhancing creativity, particularly in its area of action.

In the preferred embodiment of the present invention, and as mentioned above, synaesthesia would aid to augment or enhance the precocity of the child which leads to the creation of a child prodigy with sufficient level of motivation and persistence invested therein.

The likelihood of creating a child prodigy will increase if both parents and individuals are synaesthetes, and preferably at least one parent is a multiple synaesthete. This is because a multiple synaesthete would lead to more global, versatile precocity and prodigiousness characteristic. As briefly discussed above, and assuming that specific synaesthesias are inheritable, if a particular or specific type of precocity is desired, for instance, musical precocity, it is preferred that at least one parent should have musical synaesthesia.

It should be noted however that the type of synaesthesia may differ in the parent and child, however, wisdom dictates that it would be best if the parent exhibit the desired synaesthesia since, at least then, it is certain that the genes present are able to induce this kind of synaesthesia. This may not occur with kinds of synaesthesia other than the target one, since there is no proof of its synaesthetic manifestation in the different target area.

For instance, in the event that precocity in academic areas is desired, graphemic synaesthesia should be present in at least one of the parents. It is however strongly preferred that the parents or at least one parent exhibit multiple synaesthesia so as to acquire the required precocity in the offspring, should global precocity in the child be desired. The selection of career or profession with respect to the type of synaesthesia will be disclosed in detail later herein. (Note sound based synaesthesias will tend to predispose the child to musical career choices, overwhelming the effects of other synaesthesias.)

In the preferred embodiment of the present invention, the genetic materials may be obtained from a synaesthete individual or egg donor who may not be a prospective parent of the offspring. In the case of obtaining genetic materials from a prospective synaesthetic individual, reproduction may be carried out by means of artificial insemination, or transfer of genetic materials into the human subject i.e. child or adult, directly by standard genetic engineering methods or, indeed, by the use of natural intercourse and consequent insemination as is offered by some modern “sperm donors”.

It should be understood that the absence of medical intervention in the transfer of genetic material (ie. Natural intercourse) is not a means to circumvent the scope of protection as defined within the claims, for it achieves the same goal, of creating synaesthesia in the child, to aid the development of the mind and precocity. Of course, this identification of natural intercourse as a possible means to achieve a precocious or prodigious child, through induction of synaesthesia, is not intended to restrict ordinary family life in any way. It is only intended to include sperm donors by natural intercourse or any variant on natural insemination, in its purview.

Suitably, in accordance with the method of the present invention, to allow the presence of synaesthesia can be of various means, in which synaesthesia can be induced or inherited, imposed or taught on a human subject provided that the end result is to enhance precocity mental development, high intelligence and any form of positive mental attributes. In accordance with the present invention, and as briefly discussed in the preceding paragraphs, synaesthesia is a precocity augmenting factor, in the sense that, the presence of synaesthesia aids in augmenting the underlying cognitive abilities of the child. Thus, it is discovered that the synaesthesia will aid in enhancing the rate of mental development of the child, through enhancing the rate of information acquisition. Such conditions would aid significantly towards the creation and thus the development of a child prodigy.

The combination of genetic materials from a synaesthete and from a highly intelligent and preferably persistent individual, or any form of positive mental attributes would provide an ideal outcome. Nevertheless, either the genetic material of a synaesthete parent is combined with that of a non-synaesthetic but said individual would preferably be an intelligent and persistent parent or the genetic material of two synaesthetic parents are combined who also possess intelligence and persistence, either individually or shared between them. The likelihood of a prodigy can be substantially increased if both parents are of high intelligence and persistence in character, although this requirement is not mandatory to create a prodigy as at least one parent should preferably be of high intelligence, persistence or has any form of positive mental attributes in accordance with the present invention. In any event, synaesthesia should be present and is the most crucial attribute to produce or create a prodigy and geniuses based on the present invention.

In accordance with the preferred embodiment of the present invention, the identification of synaesthetic parents for the purpose of the method of the present invention may be identified by means of, but not limiting to a simple test or evaluation. It is understood that standard or conventional tests may be involved to ascertain the presence of synaesthesia in any of the potential parents. Such standardized tests are even available online and are readily accessible. As a further example, the intelligence of the parents can be determined using conventional IQ tests. At least one parent should be of high intelligence, although it is preferred that both parents are highly intellectual. It is expected that a higher IQ would synergize with the synaesthesia and the creation of a prodigy would be more likely.

For allowing the combination or cross linking of genetic materials from both tested parents, conventional methods may be used, including mating and any suitable approaches for instance, but not limiting to artificial insemination or pre-implantation. Accordingly, there may be provided eggs or sperm banking which offers synaesthetic genetic materials, including genetic materials from highly intelligent, persistent or individuals with any form of positive mental attributes for creation of prodigies for prospective parents. It is understood that other combinatory attempts may be performed to allow cross linking of genetic materials from the potential parents. In the preferred embodiment of the present invention, the genetic materials may be obtained by suitable means or methods from at least one individual with the desired synaesthesia.

In this preferred embodiment of the present invention, the ideal cross for producing prodigious offspring would be between two such multiply synaesthetic child prodigies, in other words both parents were prodigies. In this case, it is virtually certain that at least one of their offspring will be a synaesthetic child prodigy. A true breeding line of synaesthetic child prodigies with such combination can be created, whereby all of whom are synaesthetic and all of whom are prodigious, thereby creating a pool of prodigies.

Further in accordance with the present invention, there is a possibility of masked gifts or skills. Thereby, selection of synaesthesia to be induced must be determined based on the type of prodigy the parents wish to produce, as discussed in the previous paragraphs. For instance, musical synaesthesia as shown in our research would have a stronger influence over career choice than the other types: it tends to dominate. Thus, though having musical synaesthesia confers certain gifts, it may also provide a strong influence towards expressive creativity, in particular musical expression. There is a possibility that this may mask other gifts, which may not be worked on so much by the musical synaesthete. It would be preferred therefore, for some types of desired gifts to be evoked, to create children without the presence or criteria of musical synaethesia but with other types of synaesthesia to allow those types to have an unmasked influence.

In this preferred embodiment of the present invention, in order to enhance the likelihood of a particular type of genius being manifested in the child, it is preferred that at least one or both parents should be chosen who exhibit creativity in the desired area. The presence of a particular type of synaesthesia in the child would also guide the outcome for genius type, influencing its expression, towards the modality of the synaesthesia.

The type of synaesthesia may aid in guiding and selecting the type of career the parents would wish the child prodigy to pursue, thus gradually molding the type of genius produced. Ideally, in order to attain this, the synaesthesia should be in the same area as the creativity shown by potential parents, so as to reinforce and augment the desired combination. Nevertheless, in the event that the parents' creativity backgrounds are of different types, it is envisioned that this may result in the creation of a prodigy with an assortment of dispositions and abilities with unexpected ingenious capabilities.

Conclusively, at least one or both parents should have at least one of the following qualities or attributes in order to aid in increasing the likelihood of producing a child prodigy, but not limiting to, high quality memory, creativity, intelligence, persistence, any form of prevailing or outstanding cognitive or core capacities of the mind, enhancements and exceptional mental aptitude. This is in addition to one of the parents being a synaesthete by genetic causation, for the maximal likelihood of a prodigious or precocious outcome.

Case Study

Ainan Celeste Cawley, 10,—Multiply Synaesthetic Child Prodigy

The following case study describes synaesthesia as an imperative influence on the creation of child prodigy based on the present invention. It is intended that the specification, together with the case study, be considered exemplary only, with the scope of the invention being indicated by the claims which follow the case study.

Ainan Celeste Cawley is a multiple synaesthete and a child prodigy, more particularly, a chemistry prodigy. At the age of 7, he obtained a GCE ‘O’ Level Certificate in Chemistry. Ainan's early childhood behavior will be further disclosed herein.

Ainan's Cognitive Development

Ainan's parents, Valentine and Syahidah Osman Cawley are both artistically and intellectually gifted. Valentine is, additionally, scientifically gifted.

Ainan was very precocious, mentally and physically. (Cawley, 2006; Oelrich, 2007)

Ainan' s verbal skills developed rapidly. It is observed that he could speak in complex sentences using logical arguments when he was 12 months old that were notably rational, in content. Since then he started using logic and reason in his sentences. He would demonstrate the truth of what he had said, with an experiment. It is further observed that he would argue with the truth of the statements of adults.

Ainan's motor skills were also accelerated. He was crawling at four months, walking at six months and running at eight months. He was also able to climb into and out of his cot, at eight months. It should be noted that his walking was steady, without falling, at six months—and so, too, his running at eight months. This is evidence of effective balance. There did not appear to be a transitional period of falling as he developed these skills.

His general intellectual development showed unusual characteristics. As a toddler he appreciated science books, from the library. By three, he was interested in hyper dimensional shapes, which he would draw as 2 d representations. This would seem to indicate an advancement of spatial understanding.

At six, he revealed an interest in Chemistry, which he had taught himself on the internet. At seven years and one month old, he took and passed his Chemistry O level. It should be noted that Chemistry O level requires verbal, mathematical, spatial, logical, and conceptual and memory skills of some maturity. That he passed this exam, at such a young age, is proof that his cognitive skills were, then, at least as advanced as the minimum necessary to succeed at this examination. Given that O level is designed for the more academic 16 year olds (and 17 year olds in Singapore), this is an indication of a general precocity in the cognitive areas required, since he was ten years younger, than this, at the time of examination.

At eight, Ainan began studying third year Chemistry modules, at degree level, at Singapore Polytechnic. He also began to look at Physics. At nine years and one month, he passed Physics O level, too. He also passed AS level Chemistry at 9 and a half. At 10, he joined HELP University College, to further his studies in Computing Science, at degree level, alongside Chemistry, Physics and Maths.

Ainan's Multiple Synaesthesia

In addition to his prodigious mental development, Ainan also shows multiple synaesthesia. It is observed that he has synaesthetic responses to numbers, letters, words, musical notes, human voices and broadband sounds. Colours, textures, shapes, sounds, emotion and movement are invoked, in his responses. Some responses are bi-directional. An exemplary of Ainan's responses based on the alphabet, numbers, emotions and colors are as appended below. This is not a fully comprehensive list of his responses, which are many and complex, but only an indicator of the types of responses he shows.

### EXAMPLE 1

I. Alphabets
AlphabetAinan's Response
A orange, texture like air.
B A colour not in the rainbow—a mixture of dark brown, orangey-brown and deep rich red. Sandpaper texture.
C Bright yellow . . . WOW yellow. Slippery like ballbearings on the ground. Also 2.
D Dark blue, blue with black. Texture like a matt painted wall.
E Orangey-green. Texture like air.
F Orange-green-black. F is so yucky. Light like the foam used around the bases of plants.
G Black. Texture like the plastic surface of a computer mouse.
H Orange-Black. Texture like computer printer paper.
I Green-Black. Texture like air—like not there. Like the air is coloured like that.
J Purple. The texture of blueberry jelly.
K Light orange with white. Happy. (AHHHH! Hands waving). Texture like glossy card.
L Water. The colour of water, the texture of water . . . like that invisible light blue.
M Grey. Feels like when your feet have ants, like ants in your shoe, when your circulation stops and you get prickles.
N Orangey-pinkey-purple. Texture like glossy card.
O Light orange. Feels like the metal mesh on a speaker.
P Colour of a Caucasian's person skin. Rubbery texture (shiny rubber, springs back when touched, like boing! Makes a strange squeaking noise, like fingertips on a plastic desk), similar to that of R and 3, and red.
Q Transparent, like glass. Texture similar to the plastic used in CD cases.
R Red, 3 and rubber, “Red rough rubber”—like bitumen, in terms of its shine, but bitumen doesn't spring back. Similar shiny rubber to P.
S Orange-black-yellow . . . dirty orange-yellow. Texture of chicken feathers
T Metallic. Properties of Metal
U Hard Plastic yellow, like Bakelite
V Red-orange-yellow-brown. Texture like silly putty.
W Blue with orange. Feels like hard wood, like knocking on a table
X Black and feels like charcoal. (It has slippery surface)
Y Like the yellow of a chick. Feels like the hard black glossy plastic used to make a Samsung monitor. Also 2
Z Black but it feels like the texture of flipping through a big book (from the side, across the pages)

II. Numbers
NumberAinan's Response
1 Sky Blue. Happy
2 Yellow, like a chick, same as Y. No texture.
3 Red rough rubber. Like R and red.
4 Bright green like grass (but not dark grass). Texture like foam earplugs.
5 Dark, dark blue. Reminds me of writing.
6 Sparkly orange-yellow “eehh!”, like a plastic which reflects light, it has flashes of light on it.' Texture like the metal casing of my father's computer.
7 Colour like the orange tips of orange-yellow day lilies. A rough plastic file cover feel.
8 Purple-blue pain, like when you hit your head.
9 Ink black. Watery texture.
10 Kind of bright orange, squeaky wood texture like my father's desk.
0 Dots of orange, like tiny pixels of orange, making up the symbol zero.
III. Colours
Colour Ainan's Response
Red Red rough rubber
Orange 10
Yellow C, Y and 2
Green 4 and earplugs sponge texture
Blue 8, 5, 1
Purple 8 and water
Black 9
White Nothing

IV. Emotions
EmotionAinan' s Response
Happy 1, A, K

Ainan' s Synaesthesia as a Precocity Augmenting and Cognitive Enhancement Factor

It can be observed from the above data that Ainan's synaesthesia enriches his experience of incoming information be it aurally, visually, verbally, numerically and musically. With such cognitive enhancement he is able to store and recall stored information more expediently.

In addition, Ainan has synaesthetic responses to human voices. This may be the explanation for his accelerated speech development. It is predicted based on the occurrences as tabled out above that synaesthesia enabled him to acquire speech at an increased rate since the experience of perceiving speech was, for him, a much enriched one. He would have perceived more information in speech perhaps allowing him to acquire it more rapidly.

It can be considered based on the above study that synaesthesia would make a person more precocious, and thus is a significant causative factor towards prodigiousness.

Further, synaesthetes will be precocious in the area of their synaesthesia. For instance, a synaesthete that responds to music, will be musically precocious. A synaesthete that responds to numbers, would tend to be mathematically precocious. A synaesthete that responds to letters or words, would tend to be academically precocious and so on. It is these areas that will be more precocious than normal. Accordingly, a synaesthete will tend to be creative in the areas that are more closely related to his/her synaesthesia, owing to that fact that the synaesthete would exhibit most precocity in the said area.

Examples of famous synaesthetes who were prodigies are provided in the following column, whereby this information was obtained from published biographical materials.

List sources: Painted Senses (2007) and List of People With Synesthesia (n.d)

Note: names in bold signify that the synaesthete was also a child prodigy. The dates which follow the names, are the years of birth of the individuals concerned.
Antonio D'Abbadie 1810.
Ainan Celeste Cawley 1999
Alexander Scriabin 1872 (van Campen, 1997)
Amy Beach 1867 (Amy Beach, n.d)
Anthony Powell 1905
Baudelaire 1821
Leonard Bernstein 1918
Ben Wolfe c. post-1950
Bill Griffeth c. 1958
Blixa Bargeld 1959
Eugen Bleuler 1857
Boyce Brown 1910
Brooks Kerr 1951
Robert Cailliau 1947
Carol Steen c.1944
Stephanie Carswell 1985
Charles Blanc-Gatti 1890
Daniel Tammet 1979
Davey Havok 1975
David Hockney 1937
Duke Ellington 1899
Eddie Van Halen 1955
Elizabeth Stewart-Jones c. 1910
Ellen Fowler 1860
Elvin Jones 1927
Emile Ford 1937
Franz Liszt 1811 (Franz Liszt, n.d)
Geoffrey V. Chester c. 1929
Gyorgy Ligeti 1923
Harley Gittleman c. 1950
Helene Grimaud 1969
Henrik Wiese 1971
James Joyce 1882
Jane Mackay c.1946
Jane Yardley c.1960
Jean Sibelius 1865
Jennifer Paull 1944
Joachim Raff 1822
Johann Wolfgang von Goethe 1749 (Goethe, J., 1833)
John William Boone 1864
Jona Markgraf 1969
Joseph Long c. 1965
Julie Myerson 1960
Kilford 1975
Leonardo Da Vinci 1452 (Vasari, G., 1550)
Manu Katche 1958
Marcia Smilack c.1949
Michael Fratangelo c.1977
Michael Torke 1961
Miles Davis 1926
Nikolai Rimski-Korsakov 1844
Olivier Messiaen 1908 (Olivier Messiaen, n.d)
Baron Karl Robert Osten-Sacken 1828
Pharrell Williams 1973
Richard D. James 1971
Richard Feynman 1918 (Kennedy, J. M., 2001)
Rollo Armstrong 1967
Sabriye Tenberken 1970
Camille Saint-Saens 1835 (Camille Saint-Saens, n.d; Morton, Schmunk, 2000)
Sandy Schimmel c. post-1950
Saradzhev Konstantin 1877
Solomon Shereshevskii 1886
Speedy J 1969
Stephanie Morgenstern 1965
Steve Aylett 1967
Stevie Wonder 1950 (Stevie Wonder, n.d)
Syd Barrett 1946
Nikola Tesla 1856 (Jensen, A., 2007; Nikola Tesla, n.d; Brilliant Imaginings, n.d)
Tony DeCaprio c. 1950
Tori Amos 1963 (Tori Amos, n.d)
Trash McSweeney c.1976
Victor Hugo 1802
Vladimir Nabokov 1899 (Nabokov, D., 2006)
Wassily Kandinsky 1866
Ludwig Wittgenstein. 1889 (Jarman, 1993)

The information as set above was suitably analysed and tabulated in terms of the number of synaesthetes who were prodigies, compared to the number of synaesthetes in each fifty year period.

TABLE 1
Percentage of synaesthetes who were prodigies from 1450 to 1999

| | Number of | |
|---|---|---|
| | synaesthetic child | Percentage (%) |
| | prodigies/number | of synaesthetic |
| YEAR | of synaesthetes | prodigies |
| 1450-1499 | 1/1 | 100 |
| 1500-1549 | 0/0 | — |
| 1550-1599 | 0/0 | — |
| 1600-1649 | 0/0 | — |
| 1650-1699 | 0/0 | — |
| 1700-1749 | 1/1 | 100 |
| 1750-1799 | 0/1 | — |
| 1800-1849 | 2/7 | 28.6 |
| 1850-1899 | 5/15 | 33.3 |
| 1900-1949 | 2/19 | 10.5 |
| 1950-1999 | 3/31 | 9.7 |

Evidently, the incidence of prodigiousness among the listed 75 famous synaesthetes is substantially high, at 18.7%. This figure signifies that there is a strong linkage between synaesthesia and the development of a prodigious mind

It can be concluded that prodigiousness occurs, much more rarely, in the non-synaesthetic, general population. This would be because prodigiousness is much less likely to develop in the absence of synaesthesia as a promoting factor.

The probability of the likelihood of prodigiousness based on the above collected data can be estimated with the following equation:

X=number of child prodigies in n observations of synaesthetes;

Random variable X˜Binomial(n, p), with n=75, p=Prob(child prodigy).

The value of p is found from the equation:

0.01=P(X=14)=(75!/14!*61!)*p̂{14}*(1−p)̂{61};

Based on the above, the value of p=0.1014. This is an example of a probability of a child being prodigious that would have to be prevalent, for the observation that 14 out of 75 synaesthetes were prodigies to be significant at the 1% level. It can be seen that the chance of 14 synaesthetic prodigies occurring is only 1%, if the probability of a child being a prodigy, in the general population, is 0.1014.

Note that, in nature, there are many fewer prodigies than the one in ten, suggested by p=0.104.

Considering the fact that prodigiousness is a rare chance in nature, the observation of 14 prodigies out of 75 synaesthetes can be considered as a very significant figure.

For further observation, the probability of a child being a prodigy may be determined based on various values with the equation: P(X=14)=(75!/14!*61!)*p̂{14}*(1-p)̂{61} to get a value for the probability of 14 prodigies being observed by chance out of 75 synaesthetes.

In one embodiment of the present invention, if 1 in 1,000 children, in the general population, were prodigies, the chance of obtaining the observed results by chance would be:

P(X=14)=5.27*10̂−28 .

That is, this would occur by chance on 1 in 1.89*10̂27 occasions.

In the event that 1 in 10,000 children were prodigies;

P(X=14)=5.57*10̂−42.

This would occur by chance on 1 in 1.79*10̂41 occasions.

In the event that 1 in 100,000 children were prodigies;

P(X=14)=5.60*10̂−56.

This would occur by chance on 1 in 1.78*10̂55 occasions. In the event that 1 in 1,000,000 children were prodigies;

P(X=14)=5.61*10̂−70

This would occur by chance on 1 in 1.78 10̂69 occasions.

From the above, it is evident that the occurrence of synaesthesia is a vital catalyzing factor for the development of the prodigies as listed in the preceding paragraphs.

In another preferred embodiment of the present invention, it is observed that a prodigy arises out of the interaction of several synergistic factors: intelligence, persistence of character particularly to develop the acquired skill, quality of memory and, for many, synaesthesia.

In a further preferred embodiment of the present invention, it is observed that synaesthetes may be involved in a profession which is closely related to their synaesthesia type. TABLE 2 below provides the examples of synaesthetes and their profession(s).

TABLE 2

Synaesthetes and Their Profession(s)
Synaesthete (year born): Professional area: Type of synaesthesia:
Rollo Armstrong Music Music to Colour.
Steve Aylett Author Music to Colour
Syd Barrett Music Multiple Synaesthesia
Amy Beach Music Musical keys to Colour
Leonard Bernstein Music Timbre to Colour
Eugen Bleuler Psychiatrist Phonemes to Colour
Robert Cailliau Internet Pioneer Letters to Colour
Stephanie Carswell Actress/Singer Lexeme to Colour
Antoine D'Abbadie Geographer Number form
Tony DeCaprio Music Musical note to Colour
Duke Ellington Music Timbre to Colour
Richard Feynmann Physicist Letters/numbers to Colour
Helene Grimaud Music Numbers/Music to Colour.
David Hockney Artist Music to Colour.
Richard D. James Music Music/Words to Colour.
Kilford Artist Music to Colour
Brooks Kerr Music Musical notes to Colour.
Gyorgy Ligeti Music Grapheme to Colour
Franz Liszt Music Music to Colour.
Trash McSweeney Music Chordal Structure to Colour.
Oliver Messiaen Music Chordal Structure to Colour
Stephanie Morgenstern Actress/Director Graphemes/music to Colour
Vladimir Nabokov Author Grapheme to Colour
Joachim Raff Music Timbre to Colour
Nikolai Rimsky-Korsakov Music Musical keys to Colour
Solomon Shereshevskii Journalist/Mnemonist MultipleSynaesthesia.
Jean Sibelius Music Sound to Colour
Daniel Tammet Autistic Savant Grapheme to Colour
Sabriye Tenberken Social Worker Multiple Synaesthesia
Michael Torke Music Multiple Synaesthesia
Ludwig Wittgenstein Philosopher Grapheme to Colour
Baron K. R. Osten-Sacken Diplomat/Entomologist Number Form
Pharrell Williams Music Music to Colour
Tori Amos Music Music to Colour

It can be seen that 24 out of 33 synaesthetes are involved in creative work, this has become their profession. From here, it can be seen that there is a causative connection between the person's synaesthesia and the choice of the creative careers.

It is envisioned that musical synaesthetes or synaesthetes who respond to sounds would choose expressively creative artistic careers, provided that they do not have multiple synaesthesia or other type of synaesthesia other than musical synaesthesia. However, musical synaesthesia tends to dominate the effects of other types of synaesthesia that might be present. Thus it can be understood that, in the event that the parents would like the child to be involved in creatively artistic careers, it would be preferred that musical synaesthesia is present in any one of the parents. If the parents prefer that the child gets involved in academic or scientific or non-artistic related professions rather than artistic careers, it is preferred that musical synaesthesia is not present in any one of the parents so as to avoid masking of the effects of other synaesthesias as discussed briefly in previous paragraphs.

It should further be noted that mixed synaesthesia (including musical synaesthesia or synaesthetic response to sound) encourages expressively creative careers and may reduce the likelihood of an academically creative career choice.

In the event that the synaesthete responds to graphemes and not music, the choice of career may relate to the use of the type of said grapheme. For instance, a synaesthete that responds to words or letters may resort to a profession involving academic or literature influence or the like, such as a writer, academic or actor, while someone who responds to numbers may choose a profession related to them or become a mathematician, physicist or even a chemist or the like, or any type of profession that involves the use of numbers.

In the preferred embodiment of the present invention, in the event that an academic prodigy is desired, at least one of the contributing individuals for creation of a prodigy should be of graphemic, lexemic or other forms of word and number synaesthetes. This is to ensure that the genes are present that make this type of synaesthesia possible, although, of course, it may manifest differently in the child (inheritance pattern not known to be simply replicative of parental type, in all cases). Furthermore, the type of academic prodigy may vary, as it depends on the synaesthesia type used to create said prodigy. For instance, if one or both individuals are of words and letter synaesthetes, it will lead, if the child inherits it faithfully, to academics that involve words, while if one or both individuals are of number synaesthetes, this will lead to academics that use numbers.

In another preferred embodiment of the present invention, there is disclosed a method of creating prodigies, enhanced intellects or the like with the presence, or induced by synaesthesia, in an adult. For this embodiment, and as briefly explained within the earlier paragraphs with respect to the elucidation on the creation of child prodigies, synaesthesia may be artificially induced in the human subject i.e. adult, and thus creating a projector or an associator synaesthete. To achieve said conditions, the following steps, can be carried out on a human subject. It is understood that the number of steps for inducing synaesthesia may not be limited as described, as additional steps may be added however to achieve a similar effect of induced synaesthesia.

A preferred technique to induce synaesthesia in an adult or human subject of any age in accordance with the present invention is by means of hypnosis, in hypnotically susceptible subjects. Such induced synaesthesia would enhance the learning rate of said adult in modes related to the synaesthesia and thus would augment the precocity and intellectual abilities of the subject, over time.

Following the above, to induce synaesthesia, and thus create a projector synaesthete, the subject must by hypnotized. Then the sensory stimulus should be presented as it is desired that it should be later perceived. For instance, a coloured letter or coloured number could be presented. Next, the subject would be instructed to perceive such letters or numbers in those colours, thereafter (even if they were, for instance, merely black, in actual fact). A posthypnotic suggestion would be established that this was how the stimuli were to be thereafter perceived.

The method of presentation of stimuli used for creating a projector synaesthete under hypnosis, could also be used, with repetitive exposure and training, to create some of the effects of synaesthesia, without hypnosis. This is expected to be milder, however, than hypnotically induced synaesthesia. However, it has the merit that it will work, to the extent that it works, with people who cannot be hypnotized and thus provides an option of intervention for this class of individuals It may also be attempted to create an associator synaesthete using the method below, without hypnosis, again, however, the effect is likely to be mild.

In another approach, to create an associator synaesthete, the subject could be asked to associate a particular colour, or other sensory perception, to a particular stimulus, or could be shown the colour, or other sensory perception, that was to be associated, separately from the evoking stimulus and asked to associate it with the stimulus. A post hypnotic suggestion would be made that they would experience these associations later, after the hypnosis session. This would be an involuntary recalled association between stimulus and synaesthetic percept or concept.

For the above embodiment, a link could be created between any sensory stimulus and any sensory perception or concept, such as shape, colour, texture, emotion, sensation or indeed any other evoked understanding, at all, using hypnosis. Thus, any kind of synaesthesia could, potentially, be hypnotically entrained. This patent should cover all synaesthesias presently known or yet undiscovered, since the method would be analogous in all cases. The only thing that would change is the nature of the entrained stimulus and evoked perception or understanding.

Note that a number of hypnotic sessions might be required to build up the range of induced synaesthetic responses. Furthermore, the post hypnotically suggested synaesthesia may need to be reinforced, over time, with revision sessions, depending on whether or not it decays over time. This will vary depending on the hypnotic susceptibility of the subjects.

In another preferred embodiment of the present invention, synaesthesia may be induced by means of drugs or medications or chemical compounds or other substance of the likes, for instance, but not limiting to, MDMA, LSD, Mescaline and Ayahuasca which would result in the human subject arriving at an “altered state of consciousness”in which, not infrequently, the world is perceived synaesthetically. This synaesthesia, however, is not directly controllable as the synaesthesia induced by hypnosis is. However, in some subjects, hypnosis may be applied, during the period of intoxication with the drug, to teach the subject to perceive the world, in the altered way, by means of posthypnotic suggestion, after the drug is no longer present. Care must be taken over what is entrained, in the subject, in this manner. This method could be used to create a lasting synaesthesia. It is possible, however, that exposure to the drug itself, without hypnosis, could induce lasting perceptual after effects, possibly including synaesthetic ones.

Synaesthesia may also be attained through a state of meditation, for instance, via Zen meditation, though any other meditative method could be used, too. This often provokes a synaesthetic state. This could conceivably be combined with hypnosis to entrain the synaesthesia post-hypnotically as above or, indeed, regular meditation could give the meditator the power to control their own synaesthetic state by an act of will. Such artificially induced synaesthesia would exhibit the cognitive benefits of the other methods of achieving synaesthesia and would also enhance the development of the mind, in all ways referred to, in other examples.

It should be noted in conclusion that this patent covers using synaesthesia (induced or genetically inherited) regardless of the methods, means or approaches, to provide cognitive improvement and subsequent development of precocity in a human subject.

It is understood by a person skilled in the art that the methods, and the steps involved are described as exemplifications herein and thus the results are not intended, however, to limit or restrict the scope of the invention in any way and should not be construed as providing conditions, parameters, agents or starting materials which must be utilized exclusively in order to practice the present invention. It is therefore understood that the invention may be practiced, within the scope of the appended claims, with equivalent methods for the experiments than as specifically described and stated in claims.

1. A method for providing cognitive enhancement in a human subject, said method comprising the step of augmenting and enhancing the precocity of the human subject using synaesthesia.

2. The method as claimed in claim 1 for providing cognitive enhancement and subsequent developments of precocity in a human subject.

3. The method as claimed in claim 1 for enhancing precocity of the human subject.

4. The method as claimed in claim 1, wherein the method is for use in creating a child prodigy or prodigious genius.

5. The method as claimed in claim 1, wherein the method is used to improve the memory of the human subject.

6. The method as claimed in claim 1, wherein the method is used to improve the learning skills of the human subject.

7. The method as claimed in claim 1, wherein the method is used to increase the creativity of the human subject.

8. The method as claimed in claim 1, wherein the human subject is a child.

9. The method as claimed in claim 1, wherein the human subject is an adult.

10. The method as claimed in claim 1, wherein synaesthesia is inherited, taught in said subject or induced artificially.

11. The method as claimed in claim 1, wherein the method further comprising inducing synaesthesia artificially, including by chemical-based means, medication-based means or physical stimulation of synaesthesia.

12. The method as claimed in claim 1, wherein synaesthesia is induced by way of meditation or hypnosis or repetitive training.

13. The method as claimed in claim 11, wherein synaesthesia is induced by means of drugs, medications or chemical substance which results to the human subject to arrive at an altered state of consciousness.

14. The method as claimed in claim 13, wherein the subject would be instructed to perceive data as a synaesthete would.

15. A method for creating a child prodigy, said method comprising obtaining genetic materials from a synaesthetic individual.

16. The method as claimed in claim 15, wherein the method further includes the step of transferring said genetic materials into the child by suitable genetic engineering means.

17. The method as claimed in claim 15, wherein at least one of the individuals is of high intelligence and persistent in character.

18. A method for use in creating a genius individual, said method comprising the steps of obtaining genetic materials from a synaesthete and transferring said obtained genetic materials into the subject individual.

19. A method for creating a child prodigy, said method comprising crossing genetic materials from two individuals, wherein at least one of said individuals is a synaesthete.

20. The method as claimed in claim 20, wherein the step of crossing genetic materials includes by means of artificial insemination or natural insemination or other natural methods.

21. The method as claimed in claim 19, wherein both individuals are synaesthetes.

22. The method as claimed in claim 19, wherein the method further comprising the step of obtaining genetic materials from an individual with at least one type of synaesthesia.

23. The method as claimed in claim 19, wherein the method further comprising the step of determining the intelligence of said two individuals.

24. The method as claimed in claim 19, wherein at least one individual has high IQ.

25. The method as claimed in claim 19, wherein at least one individual is of high intelligence and persistence in character or wherein one individual is persistent and the other is intelligent, or any combination thereof.

26. The method as claimed in claim 19, wherein at least one of the individuals has any one of positive mental attributes.

27. The method as claimed in claim 19, wherein at least one individual has multiple synaesthesia.

28. The method as claimed in claim 19, wherein the type of synaesthesia influences the creativity area of the child.

29. The method as claimed in claim 19, wherein the method is used to improve the memory of the child.

30. The method as claimed in claim 19, wherein the method is used to improve the learning skills on the child.

31. The method as claimed in claim 19, wherein the method is used to increase the creativity of the child.

32. The method as claimed in claim 19, wherein the synaethesia may be induced or stimulated artificially by, medication means, chemical based means, or by way of meditation or hypnosis.

33. The method as claimed in claim 19, wherein to create an artistically expressive child prodigy, at least one individual is a musical synaesthete.

34. The method as claimed in claim 19, wherein to create a non-artistic child prodigy, none of the individuals should have musical synaesthesia.

35. The method as claimed in claim 19, wherein to create an academically gifted prodigy, at least one of the individuals should be a graphemic, lexemic or other word or number related synaesthete.

36. The method as claimed in claim 35, wherein the type of academics depends on the type of word or number or related to word and number synaesthesias involved.

37. The method as claimed in claim 1, wherein synaesthesia aids to enhance the precocity and thus memory capacity of the child.

38. The method as claimed in claim 1, wherein the type of prodigy to be created or produced is dependent on the type of synaesthesia involved.

39. The method as claimed in claim 1, wherein synaesthesia provides cognitive enhancement for the child and human subject.
